(19) United States
(12) Patent Application Publication
(10) Pub. No.: US 2026/0267525 A1
(43) Pub. Date: Sep. 10, 2026

(54) STORAGE SYSTEM AND STORAGE SYSTEM CONTROL METHOD

(71) Applicant: Hitachi Vantara, Ltd., Kanagawa-ken (JP)

(72) Inventors: Takahiro YAMAMOTO, Tokyo (JP); Norio SHIMOZONO, Tokyo (JP); Akira DEGUCHI, Tokyo (JP); Takaki MATSUSHITA, Tokyo (JP); Hiroki FUJII, Tokyo (JP)

(21) Appl. No.: 19/313,411

(22) Filed: Aug. 28, 2025

(30) Foreign Application Priority Data
Mar. 5, 2025 (JP) 2025-035012

(51) Int. Cl. G06F 3/06

(52) U.S. Cl. CPC G06F 3/0619; G06F 3/0644; G06F 3/0659; G06F 3/0665; G06F 3/0679

(57) ABSTRACT

Each of storage nodes included in a storage system includes a logical volume that stores data related to an input/output (I/O) request from a host and a plurality of storage areas having different redundancy levels, and includes a storage pool in which the data stored at an address of the logical volume is logically stored at an address mapped to the address. When performing the storage processing for the data in a physical drive, the storage system selects a storage destination area from among the plurality of storage areas based on a processing type of the I/O request that has triggered the storage processing or an importance of the data and stores the data in the selected storage destination area.

### CROSS-REFERENCE TO PRIOR APPLICATION

This application relates to and claims the benefit of priority from Japanese Patent Application number 2025-035012, filed on Mar. 5, 2025, the entire disclosure of which is incorporated herein by reference.

### BACKGROUND OF THE INVENTION

### 1. Field of the Invention

The present invention relates to a storage system and a storage system control method.

### 2. Description of the Related Art

For example, US 2024/0231706 A discloses a method of virtually cloning data between a plurality of storage systems connected via a network. In the virtual cloning of the data, a volume on a first storage system is recognized by a second storage system via the network, and a volume (virtual clone volume) on the first storage system is created on the second storage system.

Since the virtual clone volume is associated with the volume on the first storage system, a read request from a host is transferred to the corresponding volume of the first storage system when processing the read request. The first storage system processes the read request transferred from the second storage system and transmits response data to the host.

In the virtual clone volume, read data is written to a drive in the second storage system, and a mapping destination of an address range of the virtual clone volume accessed for read is changed to the drive in the second storage system to which the data is written.

In other words, in the virtual clone volume, the data read from the first storage system is stored as a cache in the local drive of the second storage system.

In addition, in the virtual clone volume, when processing a write request from the host, a mapping destination of a write destination address of the virtual clone volume is changed from the volume of the first storage system to the drive in the second storage system, and write data is written.

With such processing, in the second and subsequent accesses to the same address in the virtual clone volume, processing is performed only by the second storage system as a virtual clone destination, and thus an input/output (I/O) request is processed at high speed.

### SUMMARY OF THE INVENTION

In general, a storage system redundantly writes data in order to protect the data from a failure when writing the data. Such a data protection technology is known as redundant array of independent disks (RAID).

In a case where the virtual clone volume is provided based on the technology described in US 2024/0231706 A, when the read data is stored as a cache in the local drive, the read data is redundantly written by the RAID in order to protect the data.

In this case, since the read data is redundantly stored in the first storage system, when the read data is lost due to a failure or the like in the second storage system, the data can be acquired from the first storage system again. Therefore, in the technology disclosed in US 2024/0231706 A, the read data is redundantly stored in the second storage system, and thus capacity efficiency is reduced.

In addition, in the technology disclosed in US 2024/0231706 A, in a case where the size of the accessed region is smaller than the total drive capacity of the constructed storage system when storing the accessed region of the virtual clone volume in the local drive in the second storage system, the capacity of the storage system becomes excessive and cost efficiency is reduced.

The present invention has been made in view of the above points, and an object of the present invention is to suppress a reduction in capacity efficiency and cost efficiency when a volume is virtually cloned and used between a plurality of storage systems.

In order to achieve the above object, according to an aspect of the present invention, there is provided a storage system including a plurality of storage nodes, in which each of the storage nodes includes: a logical volume storing data related to an input/output (I/O) request from a host; a storage pool including a plurality of storage areas having different redundancy levels and in which the data stored at an address of the logical volume is logically stored at an address mapped to the address; a physical drive in which an actual content of the data logically stored in the storage pool is stored; a memory storing management information including mapping information between the address of the logical volume and the address of the storage pool; and a processor connected to the memory, and the processor selects, when performing storage processing for the data in the storage pool, a storage destination area from among the plurality of storage areas based on a processing type of the I/O request that has triggered the storage processing or an importance of the data, and stores the data in the selected storage destination area.

According to the present invention, it is possible to suppress a reduction in capacity efficiency and cost efficiency when a volume is virtually cloned and utilized between a plurality of storage systems, for example.

### BRIEF DESCRIPTION OF THE DRAWINGS

FIG. 1 is a diagram illustrating an outline of an embodiment;

FIG. 2 is a diagram illustrating a hardware configuration of a storage system according to the embodiment;

FIG. 3 is a diagram illustrating a configuration of a software platform of a site according to the embodiment;

FIG. 4 is a diagram illustrating a configuration of a storage pool according to the embodiment;

FIG. 5 is a diagram illustrating a configuration of a memory of a storage node according to the embodiment;

FIG. 6 is a diagram illustrating a configuration of a cluster management table according to the embodiment;

FIG. 7 is a diagram illustrating a configuration of a storage pool management table according to the embodiment;

FIG. 8 is a diagram illustrating a configuration of a parity group management table according to the embodiment;

FIG. 9 is a diagram illustrating a configuration of a monitoring management table according to the embodiment;

FIG. 10 is a diagram illustrating a configuration of a memory cache management table according to the embodiment;

FIG. 11 is a flowchart illustrating read processing according to the embodiment;

FIG. 12 is a flowchart illustrating write destination allocation processing according to the embodiment;

FIG. 13 is a flowchart illustrating write processing according to the embodiment;

FIG. 14 is a flowchart illustrating destaging processing according to the embodiment;

FIG. 15 is a flowchart illustrating monitoring determination processing according to the embodiment;

FIG. 16 is a flowchart illustrating capacity change processing (read) according to the embodiment;

FIG. 17 is a flowchart illustrating capacity change processing (write) according to the embodiment;

FIG. 18 is a diagram illustrating an outline of a capacity change according to the embodiment; and

FIG. 19 is a diagram illustrating an outline of multi-stage erasure coding (MEC).

### DESCRIPTION OF THE PREFERRED EMBODIMENTS

In the following description, an “interface device” may be one or more communication interface devices. The one or more communication interface devices may be one or more communication interface devices of the same type (for example, one or more network interface cards (NIC)) or two or more communication interface devices of different types (for example, an NIC and a host bus adapter (HBA)).

In the following description, a “memory” may be one or more memory devices as an example of one or more storage devices, and may typically be a main storage device. At least one memory device in the memory may be a volatile memory device or a nonvolatile memory device.

In the following description, a “drive” is a persistent storage device. Typically, the persistent storage device may be a nonvolatile storage device (for example, an auxiliary storage device), and specifically, for example, may be a hard disk drive (HDD), a solid state drive (SSD), or a non-volatile memory express (NVMe) drive.

In the following description, a “processor” may be one or more processor devices. At least one processor device may typically be a microprocessor device such as a central processing unit (CPU), and may be another type of processor device such as a graphics processing unit (GPU). At least one processor device may be a single core or a multi-core. At least one processor device may be a processor core. At least one processor device may be a processor device in a broad sense such as a hardware circuit (for example, a field-programmable gate array (FPGA), a complex programmable logic device (CPLD), or an application specific integrated circuit (ASIC)) that performs part or all of processing.

In the following description, processing may be described with a “program” as a subject. The program is executed by the processor to perform predetermined processing using the storage device and/or the interface device as appropriate. Therefore, the subject of the processing may be the processor (alternatively, a device such as a controller including the processor). The program may be installed in a device such as a computer from a program source. The program source may be, for example, a program distribution server or a computer-readable (for example, non-transitory) recording medium. In the following description, two or more programs may be implemented as one program, or one program may be implemented as two or more programs.

In addition, in the following description, information from which an output is obtained for an input may be described by an expression such as “xxx table”. However, the information may be data of any structure (for example, structured data or unstructured data), or may be a learning model represented by a neural network, a genetic algorithm, or a random forest that generates an output for an input. Therefore, the “xxx table” can be referred to as “xxx information”. In the following description, a configuration of each table is an example, and one table may be divided into two or more tables, or all or some of two or more tables may be one table.

In addition, in the following description, in case where the same type of elements are described without being distinguished, a common portion (a portion excluding a branch number) of reference numerals including the branch numbers is used, and in a case where the same type of elements are described while being distinguished, the reference numerals including the branch numbers are used. For example, in a case where physical areas are described without being particularly distinguished, the physical areas may be described as “physical area 121”, and in a case where the individual areas are described while being distinguished, the physical areas may be described as “physical area 121-1”, “physical area 121-2”, and the like.

### Outline of Embodiment

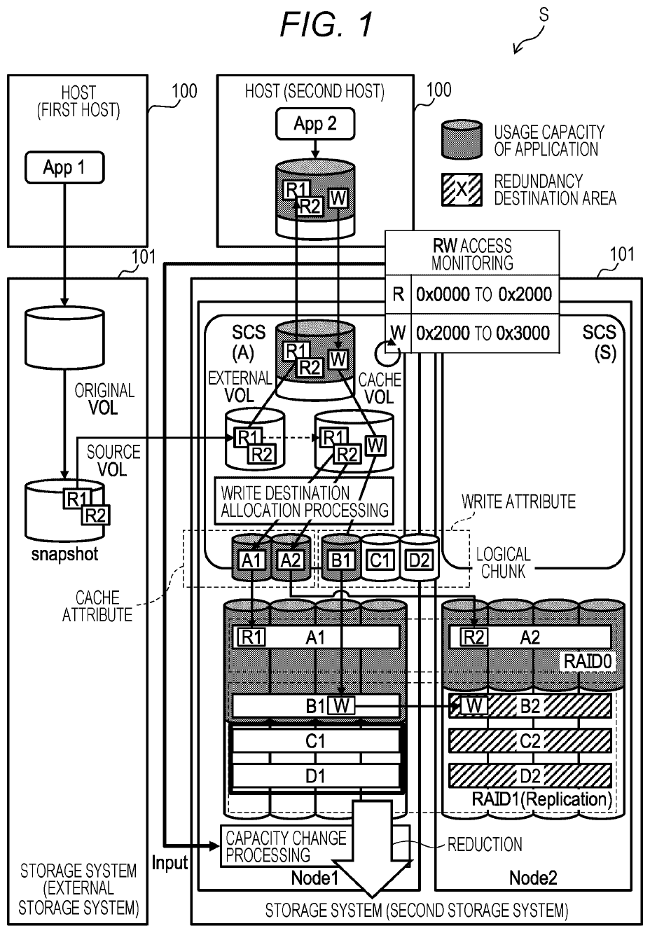

FIG. 1 is a diagram illustrating an outline of an embodiment.

An overall system S illustrated in FIG. 1 includes a plurality of storage systems 101. The plurality of storage systems 101 are connected via a network. The network is based on Internet Protocol (IP), Fibre Channel, Infiniband, or the like.

The storage system 101 (external storage system) provides a source volume (VOL) as a data access source to the storage system 101 (second storage system). In FIG. 1, a snapshot of an original VOL of the external storage system is provided as the source VOL, but the original VOL itself may be provided to the second storage system.

The second storage system registers the volume of the external storage system as an external VOL in control information thereof and provides the volume to a host 100 (second host). The second storage system processes an input/output (I/O) request for the external VOL from the second host. When the I/O request is received from the second host, the second storage system transfers the I/O request to the external storage system. The external storage system processes the I/O request transferred from the second storage system, and returns a response to the second storage system. Further, the second storage system returns a response to the host according to the response received from the external storage system.

The second storage system may associate the external VOL with a cache VOL created by the second storage system. The cache VOL is configured as a logical area of a parity group (also referred to as redundant array of independent disks (RAID)) including drives mounted on the second storage system. A plurality of types of parity groups configuring the cache VOL may be mixed, and in FIG. 1, RAID0 (a group that performs simple striping) and RAID1 (replication that creates a replica of data) are included.

An outline of I/O processing when the external VOL is associated with the cache VOL will be described. When a read request for the external VOL is received, the second storage system refers to metadata of the cache VOL corresponding to an address of an access destination. In a case where a page is allocated to the cache VOL, the second storage system reads data from the cache VOL and responds to the host.

On the other hand, in a case where no page is allocated to the cache VOL, the second storage system transfers the read request to the external storage system. Thereafter, the second storage system stores the read data read from the external storage system in the cache VOL, and allocates a page of an address accessed for read.

As described above, in the second storage system, when the external VOL is associated with the cache VOL, the first read processing is transferred to the external storage system and performed. On the other hand, the second and subsequent read processing is performed only in the second storage system by the cache VOL, so that high performance can be achieved.

Further, when storing the read data in the cache VOL, an area of RAID0 is selected and a page is allocated and stored. In RAID0, data is lost at the time of a drive failure, but even when the read data is lost, the read data can be read from the external storage system again. Therefore, the read data is written to the area of the RAID0 having excellent capacity efficiency. As a result, the logical area becomes larger than the logical area having redundancy such as RAID1, and a large amount of data can be cached, so that high performance can be expected.

When a write request for the external VOL is received, the second storage system stores write data in the cache VOL and allocates a page of an accessed address. Therefore, the second storage system can perform processing for the written area only in the second storage system at the time of the subsequent read access.

In addition, when storing the data in response to the write request, the second storage system stores the data in the logical area having redundancy such as RAID1. This is to protect the data from a drive failure or the like in a case where the write data is not transferred to the external storage system. Further, the write data is stored in a log-structured (append) format. When storing the data in the log-structured format, the write data is processed such that the data is appended to a free page in a drive area.

The second storage system monitors a read and write access history to the external VOL. In the monitoring, read and write access frequency information and information regarding the number of access pages are collected. When it is determined that a read access range is excessively wide for a current capacity of the logical area of RAID0 based on a monitoring result, the logical area and the number of drives are reduced. The monitoring is performed for write similarly to that for read, and the capacity of the logical area having redundancy such as RAID1 is changed. As a result, system cost can be reduced by adjusting a storage pool capacity provided to the cache VOL according to an access status.

### Hardware Configuration of Storage System 101 According to Embodiment

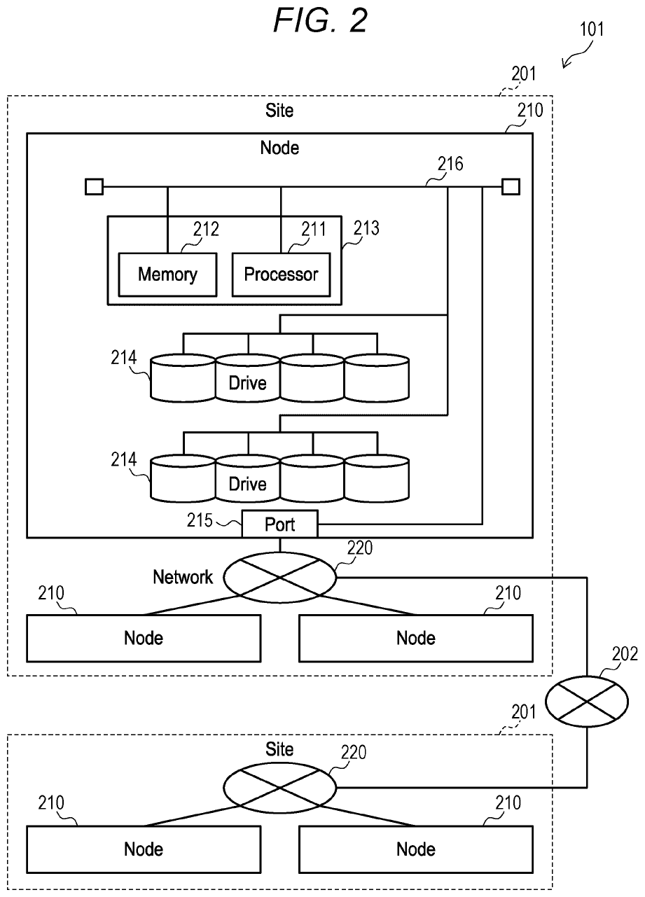

FIG. 2 is a diagram illustrating a hardware configuration of the storage system 101 according to the embodiment.

A plurality of sites 201 are communicably connected via a network 202. The network 202 is, for example, a wide area network (WAN), but is not limited to the WAN. The site 201 is a data center or the like, and includes one or more nodes 210. The site 201 includes a primary site which is a copy source of an asynchronous remote copy and a secondary site which is a destination of the copy from the primary site.

The node 210 may be a general-purpose computer. The node 210 includes, for example, one or more processor packages 213 including a processor 211, a memory 212, and the like, one or more drives 214, and one or more ports 215. These components are connected via an internal bus 216. The drive 214 is an example of the persistent storage device.

The processor 211 is, for example, a central processing unit (CPU), and performs various types of processing. The memory 212 is typically a volatile memory, and stores control information necessary for implementing a function of the node 210 and stores data. In addition, the memory 212 stores, for example, a program to be executed by the processor 211. The drive 214 stores various types of data, programs, and the like.

The port 215 is connected to a network 220 in the site 201, and communicably connects the own storage node to another node 210 in the site 201 via the network 220. The network 220 is, for example, a local area network (LAN), but is not limited to the LAN.

The physical configuration of the system is not limited to the above-described configuration. For example, the networks 202 and/or 220 may be configured with redundancy. Furthermore, for example, the network 220 may be separated into a network for management and a network for storage, a connection standard may be Ethernet (registered trademark), Infiniband, or wireless, and a connection topology is not limited to the configuration illustrated in FIG. 2. For example, the drive 214 may have a configuration independent of the node 210.

### Configuration of Software Platform of Site 201 According to Embodiment

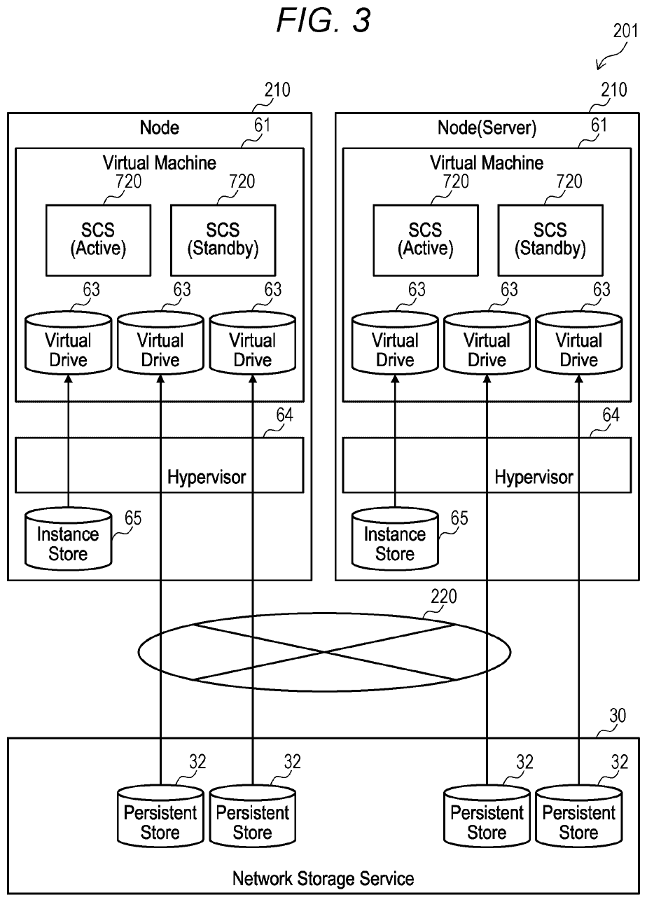

FIG. 3 is a diagram illustrating a configuration of a software platform of the site 201 according to the embodiment.

The software platform illustrated in FIG. 3 can be applied to, for example, the secondary site among the primary site and the secondary site. A network storage service 30 provides a plurality of persistent stores 32 to the plurality of nodes 210 of the site 201 (secondary site) via the network 220. The persistent store 32 is a storage area based on one or more drives 214.

The node 210 includes an instance store 65, a hypervisor 64, and a virtual machine 61. The instance store 65 is a volatile, high-speed accessible storage medium that provides block-level temporary storage for instances. The temporary storage may reside on the drive 214 physically attached to the node 210.

The hypervisor 64 dynamically generates and deletes the virtual machine 61. The virtual machine 61 manages one or more virtual drives 63 and executes storage control software (SCS) 720. The SCS 720 controls input/output (I/O) for a virtual drive 63.

The SCS 720 is made redundant between the nodes 210. That is, when a failure occurs in the node 210, the SCS (Standby) 720 of another node 210 is changed from Standby to Active instead of the SCS (Active) 720 of the node 210. The virtual drive 63 is a storage area to which the instance store 65 or the persistent store 32 is allocated. The virtual drive 63 may be treated as a VOL 102.

As described above, in the site 201, the instance store 65 by direct attached storage (DAS) and the storage (network storage service 30) via the network 220 such as iSCSI are used. For example, since the DAS and the network storage service 30 are configured on bare metal, the hypervisor 64 can be omitted.

### Configuration of Storage Pool 210PO According to Embodiment

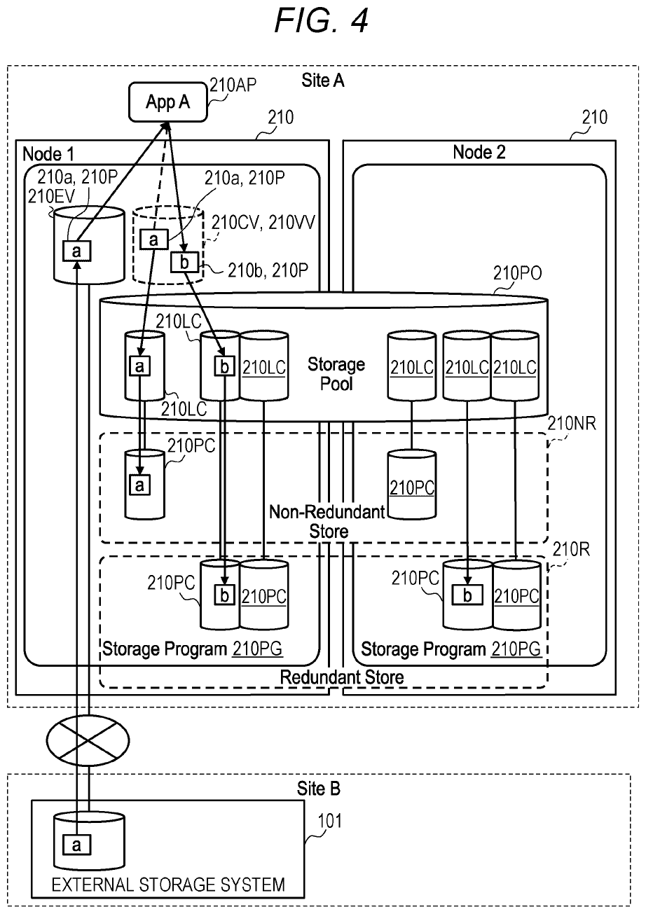

FIG. 4 is a diagram illustrating a configuration of a storage pool 210PO according to the embodiment.

The node 210 (node 1) is accessed by an application 210AP (App A). The node 210 (node 1) includes an external VOL 210EV, a cache VOL 210CV, a virtual VOL 210VV, the storage pool 210PO, a non-redundant storage area 210NR, and a redundant storage area 210R. The external VOL 210EV, the cache VOL 210CV, and the virtual VOL 210VV are collectively referred to as a logical volume 210V.

The storage pool 210PO includes a plurality of logical chunks 210LC and virtualizes the capacity of the entire storage system 101. The logical chunk 210LC is a storage area of user data excluding a parity after physical chunks 210PC are grouped into a parity group.

The parity group is a redundant group including one or more physical chunks 210PC. The user data is stored across the nodes 210 in a distributed manner by each method of RAID0, RAID1, RAID5, RAID6, erasure coding (EC), and multi-stage erasure coding (MEC) described below. In RAID0, the data is stored in a distributed manner without generating the parity (redundant data). The physical chunk 210PC is a physical storage area cut out from the drive 214.

The external VOL 210EV is a volume provided from the external storage system 101 (external storage system) as a volume providing source. In a case where the cache VOL 210CV is not associated with the external VOL 210EV, the I/O processing from the application 210AP is transferred to the external storage system and performed. The processing when the external VOL 210EV is associated with the cache VOL 210CV is as described with reference to FIG. 1.

The cache VOL 210CV and the virtual VOL 210VV are virtual volumes cut out from the storage pool 210PO. The virtual VOL 210VV becomes the cache VOL 210CV when associated with the external VOL 210EV. The cache VOL 210CV is used for positioning of a disk cache with respect to the external VOL 210EV.

The application 210AP that accesses pieces of data 210a and 210b may operate in the same node as a storage program 210PG or may operate in another node such as a host server.

For the pieces of data 210a and 210b written by the application 210AP, a page 210P of the cache VOL 210CV is allocated and stored (log-structured write).

In reading the data 210a by the application 210AP, if the page 210P of the cache VOL 210CV has been allocated, the data 210 a is read from the page 210P as an allocation destination and is returned as a response.

In reading the data 210a, in a case where the page 210P of the data 210a is not allocated to the cache VOL 210CV and the external VOL 210EV is associated with the cache VOL 210CV, the data 210a is read from the external VOL 210EV and is returned as a response. Thereafter, the read data (data 210a) is stored in the cache VOL 210CV.

On the other hand, in reading the data 210a, in a case where the page 210P of the data 210 a is not allocated to the cache VOL 210CV and the external VOL 210EV is not associated with the cache VOL 210CV, zero data is created and returned in response.

### Configuration of Memory 212 of Storage Node According to Embodiment

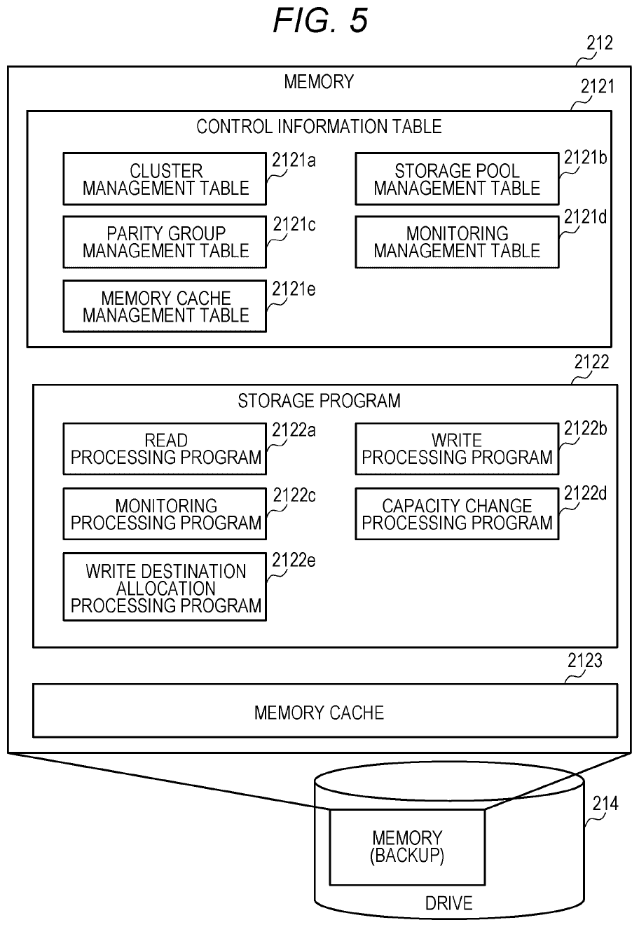

FIG. 5 is a diagram illustrating a configuration of the memory 212 of the storage node according to the embodiment. The memory 212 stores a control information table 2121, a storage program 2122, and a memory cache 2123. The control information table 2121 and the storage program 2122 are deployed in the memory 212 when necessary, and stored in a nonvolatile storing area such as the drive 214 in preparation for a power failure or the like.

The control information table 2121 includes a cluster management table 2121a, a storage pool management table 2121b, a parity group management table 2121c, a monitoring management table 2121d, and a memory cache management table 2121e. Details of these various tables are described below.

The storage program 2122 includes a read processing program 2122a, a write processing program 2122b, a monitoring processing program 2122c, a capacity change processing program 2122d, and a write destination allocation processing program 2122e. Details of these various programs are described below.

The memory cache 2123 temporarily stores data to be written to or read from the drive 214.

### Cluster Management Table 2121a According to Embodiment

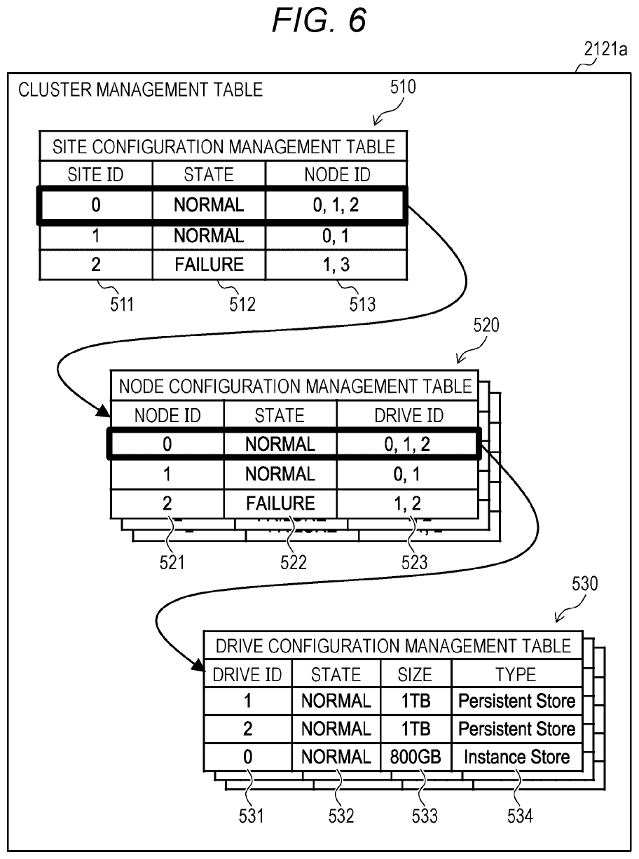

FIG. 6 is a diagram illustrating a configuration of a cluster management table 2121a according to the embodiment. The cluster management table 2121a includes a site configuration management table 510 that manages the configuration of the site 201, a node configuration management table 520 that manages the configuration of the node 210, and a drive configuration management table 530 that manages the configuration of the drive 214.

The site configuration management table 510 is managed by the storage system 101. The node configuration management table 520 is managed by the site 201 in which the corresponding node 210 is provided. The drive configuration management table 530 is managed by the node 210 in which the corresponding drive 214 is provided.

The site configuration management table 510 stores information indicating a configuration related to the site 201 (a relationship between the site 201 and the node 210, or the like). Specifically, the site configuration management table 510 stores information in which a site ID 511, a state 512, and a node ID 513 are associated with each other.

The site ID 511 is identification information that can identify the site 201. The state 512 is state information (NORMAL, WARNING, FAILURE, or the like) indicating a state of the site 201. The node ID 513 is a list of identification information that can identify the node 210 provided in the site 201.

The node configuration management table 520 is provided for each site 201 and stores information indicating a configuration related to the node 210 provided in the site 201 (a relationship between the node 210 and the drive 214, or the like). Specifically, the node configuration management table 520 stores information in which a node ID 521, a state 522, and a drive ID 523 are associated with each other.

The node ID 521 is identification information that can identify the node 210. The state 522 is state information (NORMAL, WARNING, FAILURE, or the like) indicating a state of the node 210. The drive ID 523 is a list of identification information that can identify the drive 214 provided in the node 210.

The drive configuration management table 530 is provided for each node 210 and stores information indicating a configuration related to the drive 214 provided in the node 210. Specifically, the drive configuration management table 530 stores information in which a drive ID 531, a state 532, a size 533, and a type 534 are associated with each other.

The drive ID 531 is identification information that can identify the drive 214. The state 532 is state information (NORMAL, WARNING, FAILURE, or the like) indicating a state of the drive 214. The size 533 is information indicating a capacity of the drive 214. The type 534 is information (for example, Persistent Store (persistent storage area) and Instance Store (temporary storage area)) indicating a type of the drive.

### Storage Pool Management Table 2121b According to Embodiment

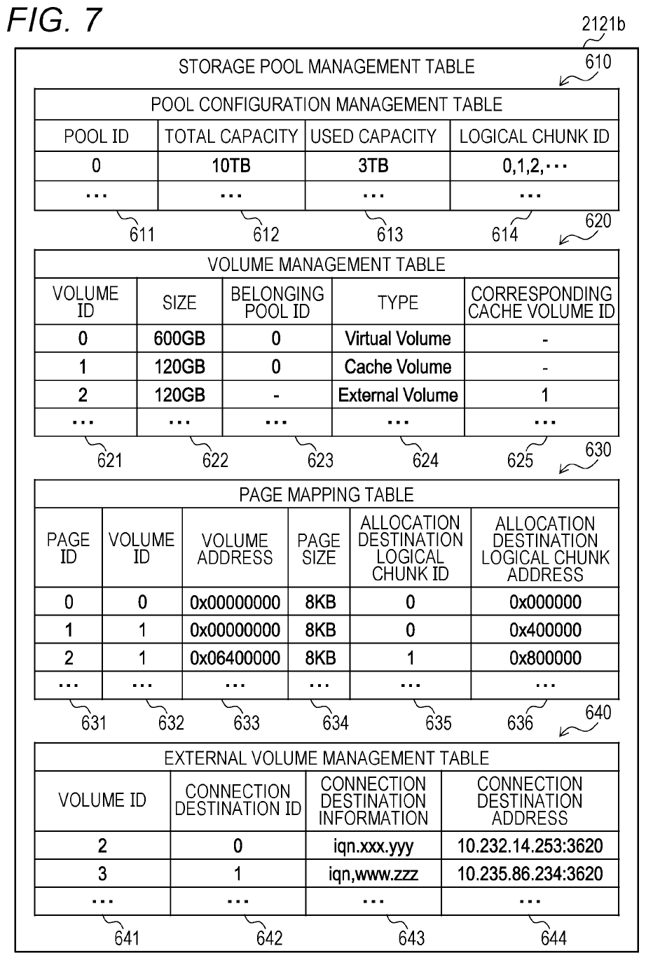

FIG. 7 is a diagram illustrating a configuration of the storage pool management table 2121b according to the embodiment. The storage pool management table 2121b stores control information for a log-structured function (thin provisioning function) provided by the storage pool 210PO. The storage pool management table 2121b is referred to when an address of the cache VOL 210CV (virtual VOL) is converted into an address of the logical chunk 210LC. A page mapping table 630 of the storage pool management table 2121b is allocated and updated each time a write request is received.

The storage pool management table 2121b includes a pool configuration information table 610, a volume management table 620, the page mapping table 630, and an external volume management table 640.

The pool configuration information table 610 stores information related to the storage pool 210PO. Specifically, the pool configuration information table 610 stores information in which a storage pool ID 611, a total capacity 612, a used capacity 613, and a logical chunk ID 614 are associated with each other.

The storage pool ID 611 is identification information that can identify the storage pool 210PO. The total capacity 612 is information indicating the total capacity of the storage pool 210PO. The used capacity 613 is information indicating a capacity used in the storage pool 210PO. The logical chunk ID 614 is a list of identification information of logical chunks included in the storage pool 210PO.

The volume management table 620 stores information related to the logical volume 210V (for example, information indicating a correspondence relationship between the logical volume 210V and the storage pool 210PO to which the logical volume 210V is allocated). Specifically, the volume management table 620 stores information in which a volume ID 621, a size 622, a belonging pool ID 623, a type 624, and a corresponding cache volume ID 625 are associated with each other.

The volume ID 621 is identification information that can identify the logical volume 210V. The size 622 is information indicating a capacity of the logical volume 210V. The belonging pool ID 623 is identification information that can identify the storage pool 210PO to which the logical volume 210V belongs. The type 624 is information indicating a type of the logical volume 210V, and includes a virtual volume, a cache volume, and an external volume. The corresponding cache volume 625 is information indicating an identifier of the cache VOL 210CV associated with the logical volume 210V.

The page mapping table 630 stores information related to the page 210P allocated to the logical volume 210V (for example, mapping information indicating a correspondence relationship between the page 210P and the logical chunk 210LC). Specifically, the page mapping table 630 stores information in which a page ID 631, a volume ID 632, a volume address (for example, logical block address (LBA)) 633, a page size 634, an allocation destination logical chunk ID 635, and an allocation destination logical chunk address 636 are associated with each other.

The page ID 631 is identification information that can identify the page 210P. The volume ID 632 is identification information that can identify the logical volume 210V to which the page 210P is allocated. The volume address 633 is information that can specify a position of the page 210P in the logical volume 210V, and is, for example, information indicating the number of pages from the first page 210P of the logical volume 210V. The page 210P is a unit for allocation of the physical area of the logical volume 210V and acquisition of access frequency information by the storage program 210PG.

The page size 634 is information indicating a capacity of the page 210P. The allocation destination logical chunk ID 635 is identification information that can identify the logical chunk 210LC corresponding to the page 210P. The allocation destination logical chunk address 636 is information that can specify a position of the logical chunk 210LC in the storage pool 210PO, and is, for example, information indicating the number of logical chunks from the first logical chunk 210LC of the storage pool 210PO.

The page size 634 may be the same for all the pages 210P, or may be different for each page 210P.

The storage program 210PG refers to the page mapping table 630 when converting an address of the logical volume 210V into an address of the storage pool 210PO. In addition, the storage program 210PG allocates the page 210P (adds a record to the page mapping table 630) every time a new write request is received.

The external volume management table 640 stores information regarding an external storage device connected to the storage system and volume information of an external storage. Specifically, a volume ID 641, a connection destination ID 642, connection destination information 643, and a connection destination address 644 are included.

The volume ID 641 is identification information that can identify a connected external volume (the type 624 of the volume management table is External Volume). The connection destination ID 642 is identification information that can identify connection information of the external storage apparatus as a connection destination. The connection destination information 643 is identification information (for example, in the case of iSCSI, IQN) necessary for connection to the external storage. The connection destination address 644 is destination information (for example, an IP address) necessary for connection to the external storage. (Parity Group Management Table 2121c According to Embodiment)

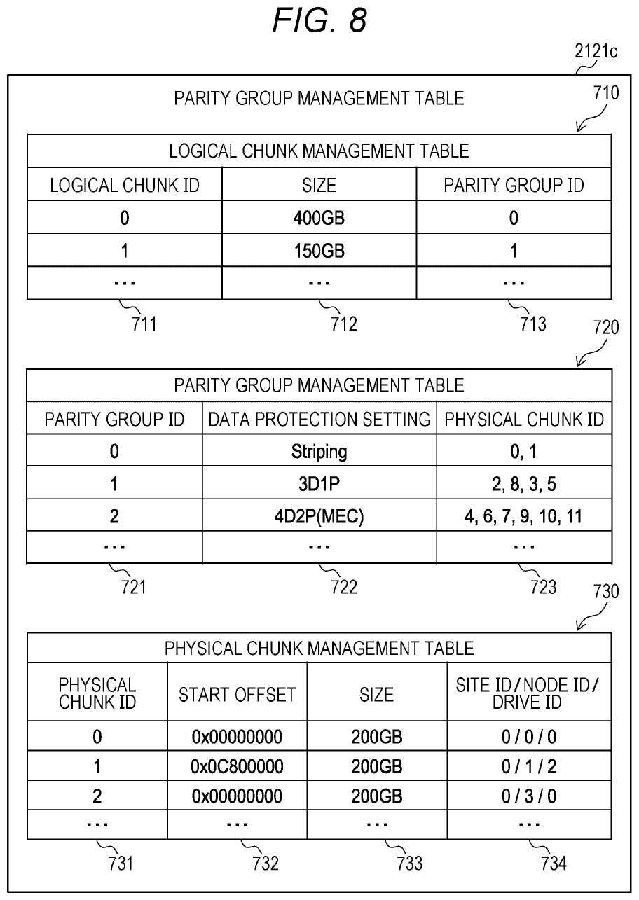

FIG. 8 is a diagram illustrating a configuration of the parity group management table 2121c according to the embodiment. The parity group management table 2121c stores control information for managing a configuration of the parity group (redundant group) configured by combining the logical chunk 210LC and the plurality of physical chunks 210PC.

The parity group management table 2121c includes a logical chunk management table 710, a parity group management table 720, and a physical chunk management table 730. The logical chunk management table 710 stores information (logical chunk information) related to the logical chunk 210LC cut out from one parity group. Specifically, the logical chunk management table 710 stores information in which a logical chunk ID 711, a size 712, and a parity group ID 713 are associated with each other.

The logical chunk ID 711 is identification information that can identify the logical chunk 210LC cut out from the parity group. The size 712 is information indicating a capacity of the logical chunk 210LC. The parity group ID 713 is identification information that can identify the parity group to which the logical chunk 210LC belongs.

The parity group management table 720 stores information (parity group information) related to the parity group. Specifically, the parity group management table 720 stores information in which a parity group ID 721, a data protection setting 722, and a physical chunk ID 723 are associated with each other.

The parity group ID 721 is identification information that can identify the parity group. The data protection setting 722 is a data protection setting of the parity group. The data protection setting includes erasure coding (m is the number of pieces of data, and n is the number of parities) including Replication and mDnP, Striping (RAID0), and the like. The physical chunk ID 723 is identification information that can identify the physical chunk 210PC allocated to a parity group 310.

The physical chunk management table 730 stores information related to the physical chunk 210PC (information for cutting out the physical area of the drive 214 by a size from a start offset and managing the physical area as the physical chunk 210PC). Specifically, the physical chunk management table 730 stores information in which a physical chunk ID 731, a start offset 732, a size 733, and a site ID/node ID/drive ID 734 are associated with each other.

The physical chunk ID 731 is identification information that can identify the physical chunk 210PC. The start offset 732 is information indicating a start position when the physical chunk 210PC is cut out from the drive 214. The size 733 is information indicating a capacity of the physical chunk 210PC. The site ID/node ID/drive ID 734 is identification information that can identify a storage resource from which the physical chunk 210PC is cut out (information indicating from which drive 214 of which node 210 of which site 201 the physical chunk 210PC is cut out).

### Monitoring Management Table 714 According to Embodiment

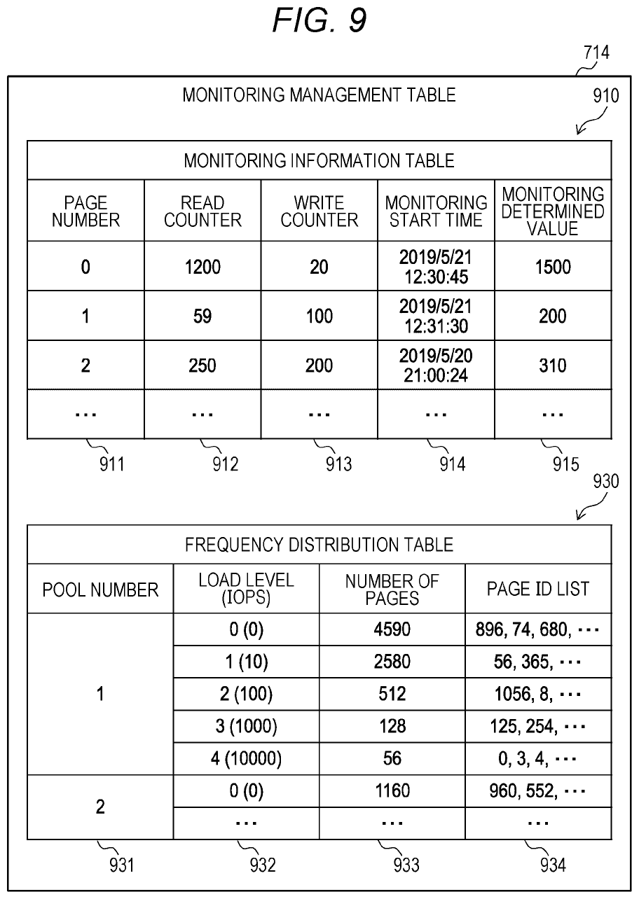

FIG. 9 is a diagram illustrating a configuration of a monitoring management table 714 according to the embodiment.

The monitoring management table 714 stores control information for managing a frequency of access to the page 210P of the logical volume 210V. The monitoring management table 714 includes a monitoring information table 910 and a frequency distribution table 930.

The monitoring information table 910 stores information regarding the frequency of access to the page 210P. Specifically, the monitoring information table 910 stores information in which a page ID 911, a read counter 912, a write counter 913, a monitoring start time 914, and a monitoring determined value 915 are associated with each other.

The page ID 911 is identification information that can identify the page 210P in the logical volume 210V. The read counter 912 is information for managing the number of times of reading of the page 210P. The write counter 913 is information for managing the number of times of writing to the page 210P. The monitoring start time 914 is information indicating a time at which monitoring of access to the page 210P is started. The monitoring determined value 915 is information indicating a determined value (monitoring determined value) of the frequency of access to the page 210P. The monitoring determined value is calculated, for example, by the following (Expression 1).

$$Monitoring determined value = ( Read counter + Write counter ) / ( Monitoring determination time - Monitoring start time ) \qquad ( Expression 1 )$$

The frequency distribution table 930 stores information in which the pages 210P are sorted in descending order of access frequency according to the monitoring determined value. Specifically, the frequency distribution table 930 stores information in which a pool ID 931, a load level 932 (input/output per second (IOPS)), the number 933 of pages, and a page ID list 934 are associated with each other.

The pool ID 931 is identification information that can identify the storage pool 210PO. The load level 932 is information for classifying the access frequency based on the load, and is, for example, a parameter set at the time of design. The number 933 of pages is information indicating the number of pages 210P belonging to the load level 932. The page ID list 934 is identification information that can identify the page 210P belonging to the load level 932.

### Memory Cache Management Table 715 According to Embodiment

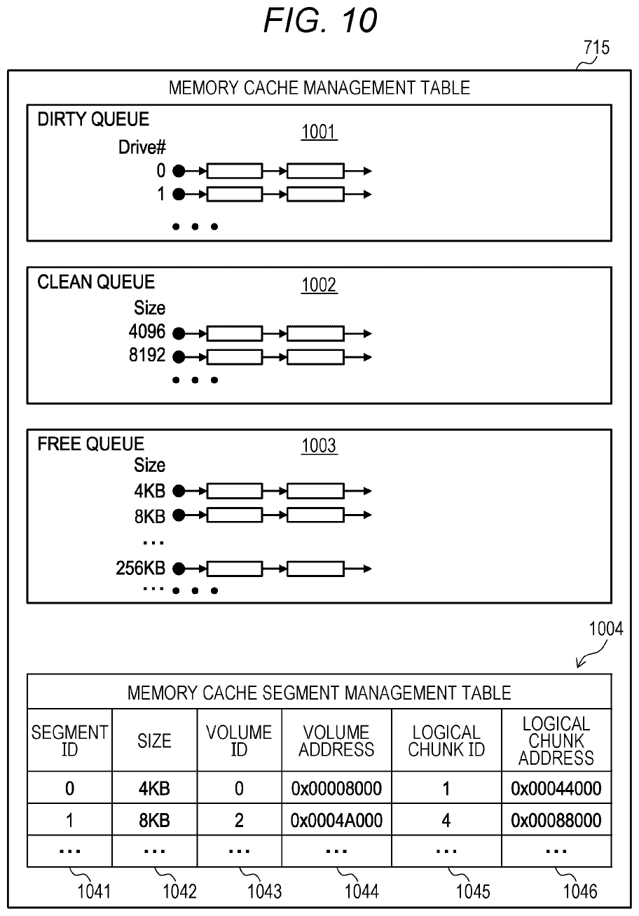

FIG. 10 is a diagram illustrating a configuration of a memory cache management table 715 according to the embodiment. The memory cache management table 715 is a table related to the memory cache 2123 and is a table for managing a cache area of the memory cache 2123. The memory cache management table 715 manages memory areas in units called segments, and manages the segments by connecting the segments to a dirty queue, a clean queue, and a free queue. The segment may be managed in a plurality of units different for each size, or may be managed in a variable size according to a cache securing request.

The memory cache management table 715 includes a dirty queue 1001, a clean queue 1002, a free queue 1003, and a cache segment management table 1004.

The dirty queue 1001 is a queue of an ID (address) of a dirty segment in which dirty data to be written to the drive 214 is stored for each drive 214. The “dirty segment” is a segment in which the dirty data is stored. The “dirty data” is data that has not been written to the drive 214.

The clean queue 1002 is a queue of IDs (addresses) of clean segments each having a corresponding segment size for each segment size. The “clean segment” is a segment in which clean data is stored. The “clean data” is data written in the drive 214.

The free queue 1003 is a queue of IDs (addresses) of free segments each having a corresponding segment size for each segment size. The “free segment” is a segment to which data may be newly written. A segment of a desired size is secured from the free queue 1003, and the data is written to the secured segment.

The cache segment management table 1004 stores information regarding a cache segment. The cache segment management table 1004 stores information such as a segment ID 1041, a size 1042, a volume ID 1043, a volume address 1044, a logical chunk ID 1045, and a logical chunk address 1046 for each cache segment.

The segment ID 1041 is an ID of the cache segment. The size 1042 is a size of the cache segment. The volume ID 1043 is an ID of the logical volume 210V corresponding to the data in the cache segment. The volume address 1044 is an address in the logical volume 210V corresponding to data in the cache segment. The logical chunk ID 1045 is an ID of the logical chunk 210LC to be a storage destination of the data in the cache segment. The logical chunk address 1046 is an address of the logical chunk 210LC to be a storage destination of the data in the cache segment.

### Read Processing According to Embodiment

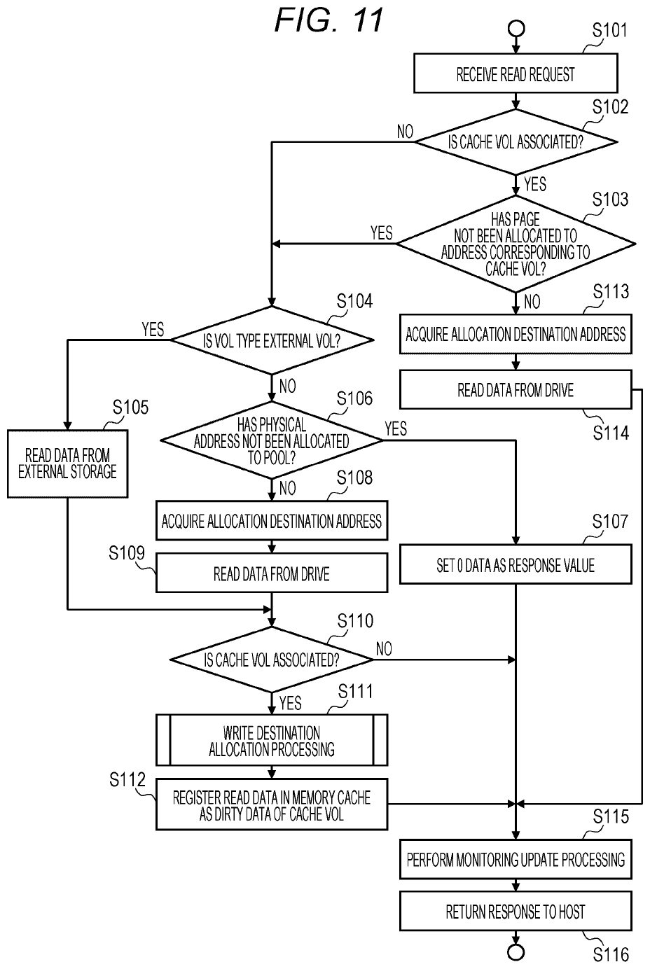

FIG. 11 is a flowchart illustrating the read processing according to the embodiment. The read processing is processing of reading the data from the drive 214 in response to the read request from the host 100.

First, in step S101, the read processing program 2122a receives the read request from the host 100. Next, in step S102, the read processing program 2122a determines whether or not the cache VOL 210CV is associated with the logical volume 210V for which the read request has been received in step S101 by referring to the volume management table 620. In a case where the cache VOL 210CV is associated (Yes in step S102), the read processing program 2122a advances the processing to step S103. On the other hand, in a case where the cache VOL 210CV is not associated (step S102: NO), the read processing program 2122a advances the processing to step S104.

In step S103, the read processing program 2122a determines whether or not the page 210P has not been allocated to an address corresponding to the cache VOL 210CV determined to be associated in step S102. In a case where the page 210P has not been allocated (Yes in step S103), the read processing program 2122a advances the processing to step S104. On the other hand, in a case where the page 210P has been allocated (No in step S103), the read processing program 2122a advances the processing to step S113.

In step S104, the read processing program 2122a determines whether or not a VOL type of the logical volume 210V for which a negative determination (No) is made in step S102 is the external VOL by referring to the volume management table 620. In a case where it is determined that the VOL type is the external VOL (Yes in step S104), the read processing program 2122a advances the processing to step S105. On the other hand, in a case where it is determined that the VOL type is the cache VOL 210CV or the virtual VOL 210VV (No in step S104), the read processing program 2122a advances the processing to step S106.

In step S105, the read processing program 2122a reads the data from the external storage that provides the external VOL 210EV. Upon completion of step S105, the read processing program 2122a advances the processing to step S110.

In step S106, the read processing program 2122a determines whether or not a physical address has not been allocated to the storage pool 214PO. In a case where the physical address has not been allocated to the storage pool 214PO (Yes in step S106), the read processing program 2122a advances the processing to step S107. On the other hand, in a case where the physical address has not been allocated to the storage pool 214PO (No in step S106), the read processing program 2122a advances the processing to step S108.

In step S107, the read processing program 2122a sets 0 data as a response value. Upon completion of step S107, the read processing program 2122a advances the processing to step S115.

In step S108, the read processing program 2122a acquires an allocation destination address allocated to the storage pool 214PO. Next, in step S109, the read processing program 2122a reads the data from the drive 214 based on the address acquired in step S108.

Next, in step S110, the read processing program 2122a determines whether or not the cache VOL 21CV is associated. In a case where the cache VOL 21CV is associated (Yes in step S110), the read processing program 2122a advances the processing to step S111. On the other hand, in a case where the cache VOL 21CV is not associated (step S116: NO), the read processing program 2122a advances the processing to step S115.

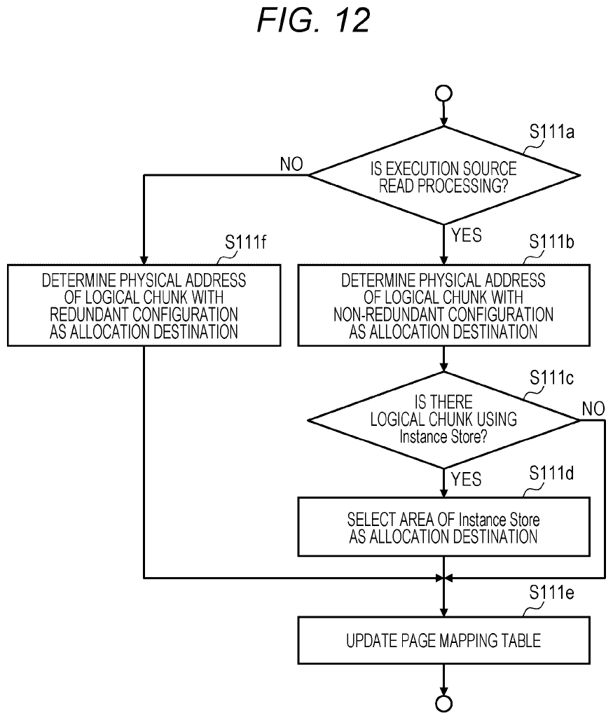

In step S111, the read processing program 2122a performs write destination allocation processing by the write destination allocation processing program 2122e. Details of the write destination allocation processing are described below with reference to FIG. 12. Next, in step S112, the read processing program 2122a registers the read data in the memory cache 2123 as the dirty data of the cache VOL 210CV. When step S112 ends, the read processing program 2122a advances the processing to step S115.

On the other hand, in step S113, the read processing program 2122a acquires the allocation destination address of the page 210P. Next, in step S114, the read processing program 2122a reads the data from the drive 214 based on the allocation destination address acquired in step S113.

Next, in step S115, the read processing program 2122a performs monitoring update processing by the monitoring processing program 2122c. The monitoring processing program 2122c adds 1 to the read counter 912 of the page 210P to be read to update in the monitoring information table 910. Next, in step S116, the read processing program 2122a transmits a response to the host 100.

### Write Destination Allocation Processing According to Embodiment

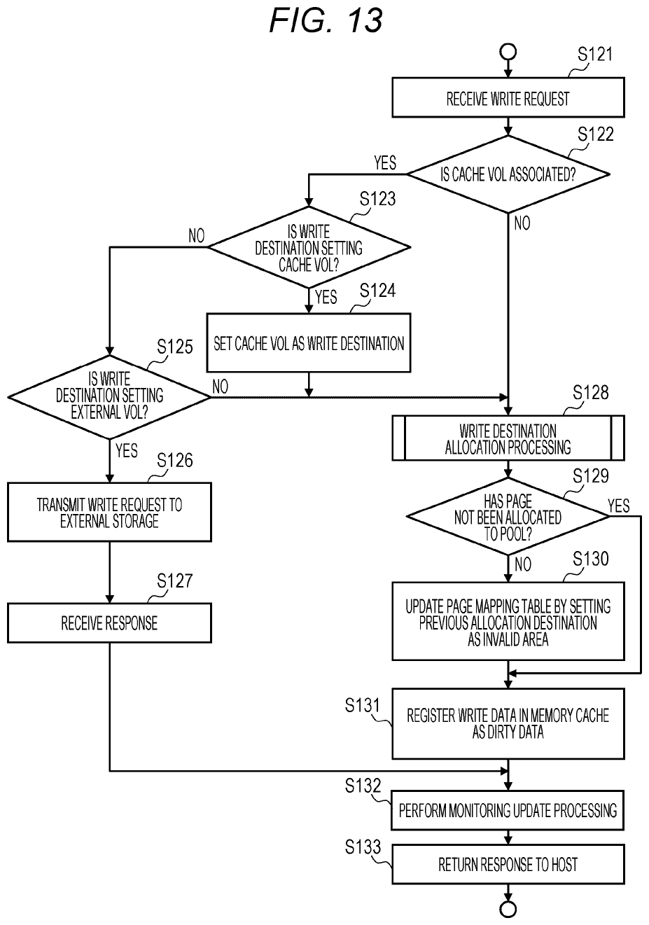

FIG. 12 is a flowchart illustrating the write destination allocation processing according to the embodiment. The write destination allocation processing is triggered from step S111 (FIG. 11) of the read processing and step S128 (FIG. 13) of write processing.

First, in step S111a, the write destination allocation processing program 2122e determines whether or not an execution source is the read processing (step S111 in FIG. 11). In a case where the execution source is the read processing (step S111a: Yes), the write destination allocation processing program 2122e advances the processing to step S111b. On the other hand, in a case where the execution source is the write processing (step S128 in FIG. 13) (step S111a: No), the write destination allocation processing program 2122e advances the processing to step S111f.

In step S111b, the write destination allocation processing program 2122e determines a physical address of the logical chunk 210LC with a non-redundant configuration (RAID0) as an allocation destination. Next, in step S111c, the write destination allocation processing program 2122e determines whether or not there is a logical chunk 210LC using the instance store 65. In a case where there is a logical chunk 210LC using the instance store 65 (step S111c: Yes), the write destination allocation processing program 2122e advances the processing to step S111d. On the other hand, in a case where there is no logical chunk 210LC using the instance store 65 (step S111 c: No), the write destination allocation processing program 2122e advances the processing to step S111e.

In step S111d, the write destination allocation processing program 2122e selects an area of the instance store 65 as an allocation destination. Upon completion of step S111d, the write destination allocation processing program 2122e advances the processing to step S111e.

On the other hand, in step S111f, the write destination allocation processing program 2122e determines the physical address of the logical chunk 210LC with a redundant configuration (RAID1, RAID5, RAID6, EC, or MEC) as the allocation destination. Upon completion of step S111f, the write destination allocation processing program 2122e advances the processing to step S111e.

In step S111e, the write destination allocation processing program 2122e updates the page mapping table 630 according to the determinations in steps S111b, S111d, and S111f.

### Write Processing According to Embodiment

FIG. 13 is a flowchart illustrating the write processing according to the embodiment. The write processing is processing of storing data and a parity in response to the write request from the host 100. The write processing is processing until the write data is registered in the memory cache as the dirty data.

First, in step S121, the write processing program 2122b receives the write request from the host 100. Next, in step S122, the write processing program 2122b determines whether or not the cache VOL 210CV is associated with the logical volume 210V for which the write request has been received in step S121 by referring to the volume management table 620. In a case where the cache VOL 210CV is associated (Yes in step S122), the write processing program 2122b advances the processing to step S123. On the other hand, in a case where the cache VOL 210CV is not associated (step S122: NO), the write processing program 2122b advances the processing to step S128.

In step S123, the write processing program 2122b determines whether or not a write destination setting of the logical volume 210V determined to be associated with the cache VOL 210CV in step S122 is the cache VOL by referring to the volume management table 620. In a case where it is determined that the write destination setting is the cache VOL (Yes in step S123), the write processing program 2122b advances the processing to step S124. On the other hand, in a case where it is determined that the write destination setting is the external VOL or the virtual VOL (No in step S123), the write processing program 2122b advances the processing to step S125.

In step S124, the write processing program 2122b sets the cache VOL 210CV as a write destination. Upon completion of step S124, the write processing program 2122b advances the processing to step S128.

On the other hand, in step S125, the write processing program 2122b determines whether or not the write destination setting is the external VOL. In a case where it is determined that the write destination setting is the external VOL (Yes in step S125), the write processing program 2122b advances the processing to step S126. On the other hand, in a case where it is determined that the write destination setting is the virtual VOL (No in step S125), the write processing program 2122b advances the processing to step S128.

In step S126, the write processing program 2122b transmits the write request to the external storage. Next, in step S127, the write processing program 2122b receives a response to the write request in step S126. Upon completion of step S127, the write processing program 2122b advances the processing to step S132.

On the other hand, in step S128, the write processing program 2122b performs the write destination allocation processing. Details of the write destination allocation processing are as described with reference to FIG. 12. Next, in step S129, the write processing program 2122b determines whether or not a page has been allocated to the storage pool 210PO in the write destination allocated in step S128. In a case where it is determined that the page has not been allocated to the storage pool 210PO (Step S129: Yes), the write processing program 2122b advances the processing to Step S131. On the other hand, in a case where it is determined that the page has been allocated to the storage pool 210PO (No in step S129), the write processing program 2122b advances the processing to step S130.

In step S130, the write processing program 2122b updates the page mapping table 630 by setting a previous allocation destination as an invalid area (log-structured processing, discarding a previous allocation page), and writes the data to a new page. The invalid page is collected as the free page by periodic garbage collection processing.

Next, in step S131, the write processing program 2122b registers the write data in the memory cache 2123 as the dirty data. Next, in step S132, the write processing program 2122b performs the monitoring update processing by the monitoring processing program 2122c. The monitoring processing program 2122c adds 1 to the write counter 913 of the page 210P to be written to update in the monitoring information table 910. Next, in step S133, the write processing program 2122b transmits a response to the host 100.

### Destaging Processing According to Embodiment

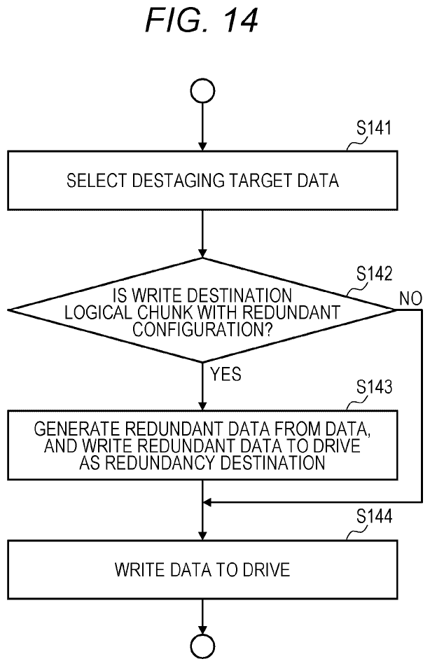

FIG. 14 is a flowchart illustrating destaging processing according to the embodiment. The destaging processing is processing of redundantly writing the dirty data on the memory cache 2123 generated in the read processing (FIG. 11) and the write processing (FIG. 13) to the drive 214 on a regular basis.

First, in step S141, the write processing program 2122b selects destaging target data. In step S141, the dirty data generated by not only the write processing but also the read processing is also targeted, and the segment is acquired from the dirty queue 1001.

Next, in step S142, the write processing program 2122b determines whether or not the write destination is the logical chunk with the redundant configuration (RAID1, RAID5, RAID6, EC, or MEC). In a case where the write destination is the logical chunk with the redundant configuration (Yes in step S142), the write processing program 2122b advances the processing to step S143. On the other hand, in a case where the write destination is the logical chunk with the non-redundant configuration (RAID0) (No in step S142), the write processing program 2122b advances the processing to step S144.

Next, in step S143, the write processing program 2122b generates the redundant data from the destaging target data selected in step S141, and writes the redundant data to the drive 214 as a redundancy destination. Next, in step S144, the write processing program 2122b writes the destaging target data to the drive 214.

### Monitoring Determination Processing According to Embodiment

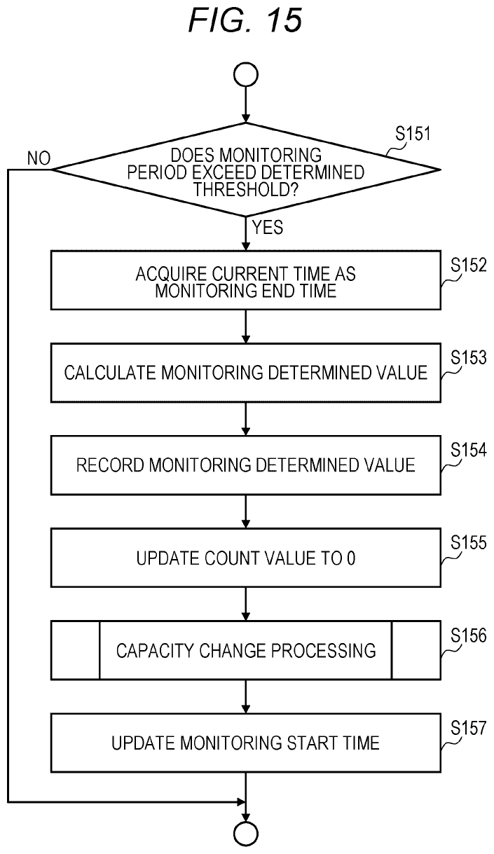

FIG. 15 is a flowchart illustrating monitoring determination processing according to the embodiment. The monitoring determination processing is performed periodically, or every read monitoring period or every write monitoring period.

First, in step S151, the monitoring processing program 2122c determines whether or not the monitoring period exceeds a determined threshold (a predetermined value such as one day or one week) (that is, one monitoring period ends). The monitoring period is a value obtained by subtracting the monitoring start time 914 from a current time. In a case where the monitoring period exceeds the determined threshold (Yes in step S151), the monitoring processing program 2122c advances the processing to step S152. On the other hand, in a case where the monitoring period does not exceed the determined threshold (No in step S151), the monitoring processing program 2122c ends the monitoring determination processing.

In step S152, the monitoring processing program 2122c acquires the current time as a monitoring end time. The monitoring end time acquired in step S152 is the monitoring start time 914 of the next monitoring period. Next, in step S153, the monitoring processing program 2122c calculates the monitoring determined value 915 based on (Expression 1) described above. Next, in step S154, the monitoring processing program 2122c records the monitoring determined value 915 calculated in step S153 in the monitoring information table 910.

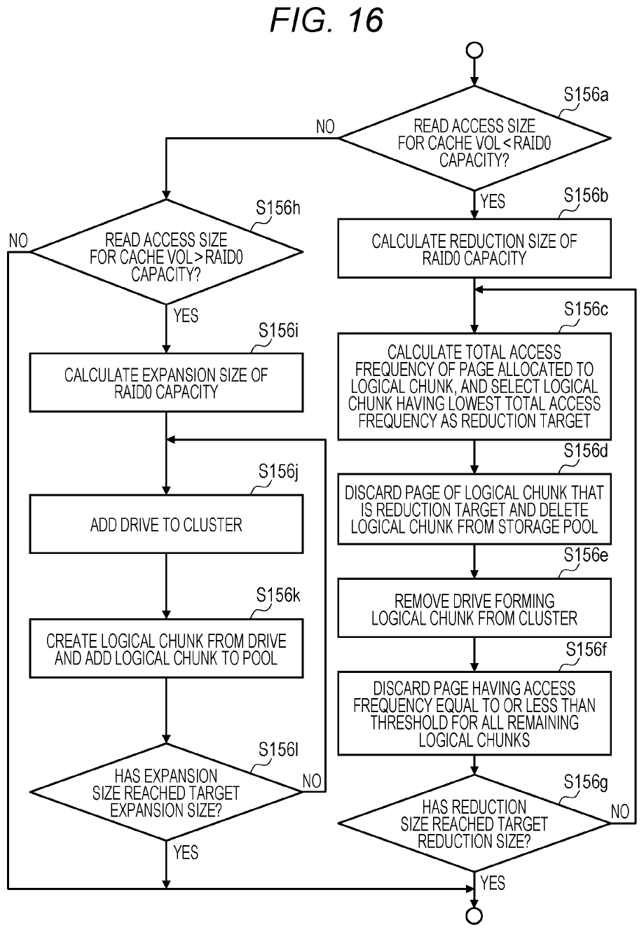

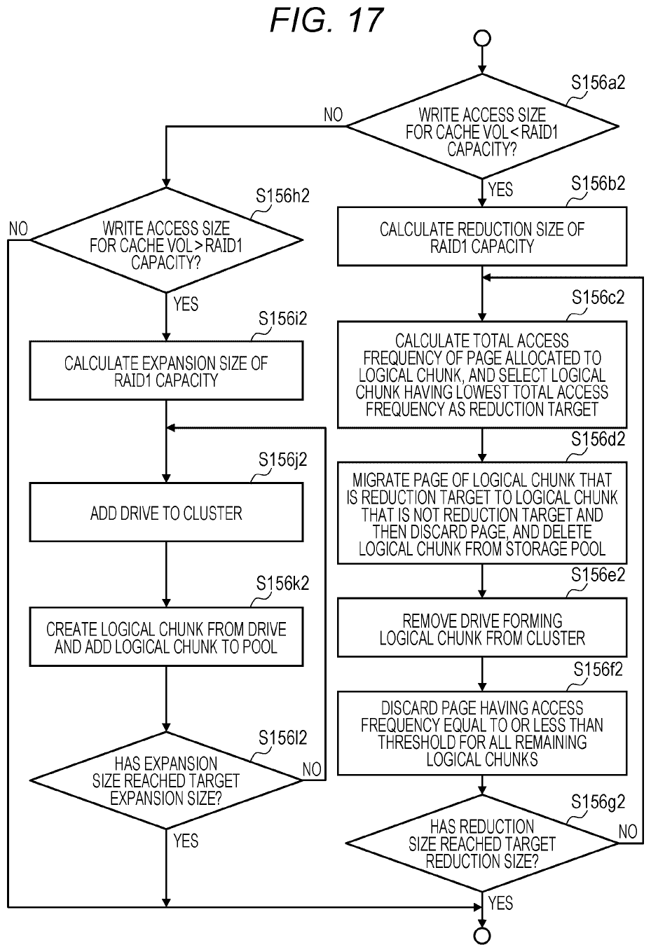

Next, in step S155, the monitoring processing program 2122c updates count values of the read counter and the write counter to 0. Next, in step S156, the monitoring processing program 2122c performs capacity change processing by the capacity change processing program 2122d. Details of the capacity change processing are described below with reference to FIGS. 16 and 17.

Next, in step S157, the monitoring processing program 2122c sets the monitoring start time of the next monitoring period based on the monitoring end time acquired in step S152.

### Capacity Change Processing (Read) According to Embodiment

FIG. 16 is a flowchart illustrating the capacity change processing (read) according to the embodiment. The capacity change processing (read) is triggered from step S156 (FIG. 15) of the monitoring determination processing. In the capacity change processing (read), an area size (capacity) of the non-redundant configuration (RAID0) of the storage pool 210PO as a data storage destination of the cache VOL 210CV is changed based on a read access size (access range).

First, in step S156a, the capacity change processing program 2122d determines whether or not the read access size for the cache VOL 210CV is smaller than a current RAID0 capacity. The read access size for the cache VOL 210CV and the current RAID0 capacity are examples of thresholds calculated based on the capacity of the storage pool 210PO (non-redundant storage area 210NR). If a difference between the read access size and the current RAID0 capacity is equal to or larger than a predetermined reduction/expansion unit, a magnitude relationship between the read access size and the current RAID0 capacity is determined.

In a case where the read access size for the cache VOL 210CV is smaller than the current RAID0 capacity (step S156a: Yes), the capacity change processing program 2122d advances the processing to step S156b. On the other hand, in a case where the read access size for the cache VOL 210CV is equal to or larger than the current RAID0 capacity (step S156a: No), the capacity change processing program 2122d advances the processing to step S156h.

In step S156b, the capacity change processing program 2122d calculates a reduction size (target reduction size) of the RAID0 capacity. The target reduction size is, for example, a value that is a multiple of the above-described predetermined reduction/expansion unit, and is a value equal to or less than the difference between the read access size for the cache VOL 210CV and the current RAID0 capacity.

Next, in step S156c, the capacity change processing program 2122d calculates the total access frequency of the page 210P allocated to the logical chunk 210LC. Then, the capacity change processing program 2122d selects, as a reduction target, the logical chunk 210LC having the lowest total access frequency, which corresponds to the reduction size calculated in step S156b.

Next, in step S156d, the capacity change processing program 2122 d discards the page 210P of the logical chunk 210LC that is the reduction target selected in step S156c, and deletes the logical chunk 210LC from the storage pool 210PO. In order to prevent a data loss, at the time of monitoring update for write (expansion/reduction in the capacity of RAID 1 or the like), the page 210P of the logical chunk 210LC that is the reduction target is migrated (moved) to the page 210P on which there is a free space in the logical chunk 210LC that is a non-reduction target and then discarded.

Next, in step S156e, the capacity change processing program 2122d removes the drive 214 forming the logical chunk 210LC deleted in step S156d from a cluster of the nodes 210.

Next, in step S156f, the capacity change processing program 2122 d discards the page 210P having an access frequency equal to or lower than a threshold for all the remaining logical chunks 210LC. In step S156f, the page 210P having a low access frequency is discarded, and the page 210P having a high access frequency is left in the cache VOL 210CV. In the case of RAID1, step S156f is omitted.

Next, in step S156g, the capacity change processing program 2122d determines whether or not the reduction size of the RAID0 capacity in steps S156c to S156f has reached the target reduction size calculated in step S156b. In a case where the reduction size of the RAID0 capacity has reached the target reduction size (step S156g: Yes), the capacity change processing program 2122d ends the capacity change processing. On the other hand, in a case where the reduction size of the RAID0 capacity has not reached the target reduction size (step S156g: No), the capacity change processing program 2122d returns the processing to step S156c.

On the other hand, in step S156h, the capacity change processing program 2122d determines whether or not the read access size for the cache VOL 210CV is larger than the RAID0 capacity. In a case where the read access size for the cache VOL 210CV is larger than the RAID0 capacity (step S156h: Yes), the capacity change processing program 2122d advances the processing to step S156i. On the other hand, in a case where the read access size for the cache VOL 210CV is equal to the RAID0 capacity (step S156h: No), the capacity change processing program 2122d ends the capacity change processing.

The threshold used for the determination of the read access size in step S156h is not limited to the RAID0 capacity, and may be another value calculated based on a capacity of the non-redundant storage area 210NR.

In step S156i, the capacity change processing program 2122d calculates an expansion size (target expansion size) of the RAID0 capacity. The target expansion size is, for example, a value that is a multiple of the above-described predetermined reduction/expansion unit, and is a value equal to or less than the difference between the read access size for the cache VOL 210CV and the current RAID0 capacity.

Next, in step S156j, the capacity change processing program 2122d adds the drive 214 having a capacity that can cover the expansion size calculated in step S156i to the cluster of the nodes 210.

Next, in step S156k, the capacity change processing program 2122d creates the logical chunk 210LC from the drive 214 and adds the created logical chunk 210LC to the storage pool 210PO. In step S156k, among the created logical chunks 210LC, the logical chunk 210LC residing in the same node as the node 210 including the cache VOL 210CV is preferentially allocated to the storage pool 210PO.

Next, in step S156l, the capacity change processing program 2122d determines whether or not the expansion size of the RAID0 capacity in steps S156j to S156k has reached the target expansion size calculated in step S156i. In a case where the expansion size of the RAID0 capacity in step S156e has reached the target expansion size (step S156l: Yes), the capacity change processing program 2122d ends the capacity change processing. On the other hand, in a case where the expansion size of the RAID0 capacity in step S156e has not reached the target expansion size (step S156l: No), the capacity change processing program 2122d returns the processing to step S156j.

### Capacity Change Processing (Write) According to Embodiment

FIG. 17 is a flowchart illustrating the capacity change processing (write) according to the embodiment. The capacity change processing is performed subsequent to step S156g or S156l of the capacity change processing (read) (FIG. 16). In the capacity change processing (write), an area size (capacity) of the redundant configuration (RAID1) of the storage pool 210PO as a data storage destination of the cache VOL 210CV is changed based on a write access size (access range).

Steps S156a2, S156b2, S156d2, S156h2, and S156i2 in the capacity change processing (write) are different from steps S156a, S156b, S156d, S156h, and S156i in the capacity change processing (read) (FIG. 16), respectively. On the other hand, steps S156c2, S156e2 to S156g2, and S156j2 to S156l2 are the same as steps S156c, S156e to S156g, and S156j to S156l, respectively.

In step S156a, the capacity change processing program 2122d determines whether or not the write access size for the cache VOL 210CV is smaller than a current RAID1 capacity. The write access size for the cache VOL 210CV and the current RAID1 capacity are examples of thresholds calculated based on the capacity of the storage pool 210PO (redundant storage area 210R). If a difference between the write access size and the current RAID1 capacity is equal to or larger than a predetermined reduction/expansion unit, a magnitude relationship between the write access size and the current RAID1 capacity is determined.

In a case where the write access size for the cache VOL 210CV is smaller than the current RAID1 capacity (step S156a2: Yes), the capacity change processing program 2122d advances the processing to step S156b2. On the other hand, in a case where the write access size for the cache VOL 210CV is equal to or larger than the current RAID1 capacity (step S156a2: No), the capacity change processing program 2122d advances the processing to step S156h2.

In step S156b2, the capacity change processing program 2122d calculates a reduction size of the RAID1 capacity. In step S156d2, the capacity change processing program 2122 d migrates a recorded content of the page 210P of the logical chunk 210LC that is a reduction target selected in step S156c2 to the logical chunk 210LC that is a non-reduction target. Then, the capacity change processing program 2122d discards the page 210P for which the migration is completed, and deletes the logical chunk 210LC from the storage pool 210PO.

On the other hand, in step S156h2, the capacity change processing program 2122d determines whether or not the write access size for the cache VOL 210CV is larger than the RAID1 capacity. In a case where the write access size for the cache VOL 210CV is larger than the RAID1 capacity (Yes in step S156h2), the capacity change processing program 2122d advances the processing to step S156i2. On the other hand, in a case where the write access size for the cache VOL 210CV is equal to the RAID1 capacity (No in step S156h2), the capacity change processing program 2122d ends the capacity change processing.

The threshold used for the determination of the write access size in step S156h2 is not limited to the RAID1 capacity, and may be another value calculated based on a capacity of the redundant storage area 210R.

In step S156i2, the capacity change processing program 2122d calculates an expansion size (target expansion size) of the RAID1 capacity. The target expansion size is, for example, a value that is a multiple of the above-described predetermined reduction/expansion unit, and is a value equal to or less than the difference between the write access size for the cache VOL 210CV and the current RAID1 capacity.

Processing of steps other than those described above is similar to the capacity change processing (read).

In the capacity change processing of FIGS. 16 and 17 described above, whether or not the capacity expansion or reduction can be performed is evaluated based on the access range. However, whether or not the capacity expansion or reduction can be performed may also be evaluated based on an access rate to the cache VOL 210CV. The capacity may be adjusted to a size at which the access rate reaches a target access rate based on the monitoring determined value 915 of the monitoring management table 714.

In addition, an execution order of the capacity change processing (read) (FIG. 16) and the capacity change processing (write) (FIG. 17) may be switched.

When increasing the cache capacity (steps S156k (FIG. 16) and S156k2 (FIG. 17)), in a case where the logical chunk 210LC cannot be secured in the corresponding node 210 having the cache VOL 210CV, the logical chunk 210LC of another node 210 is secured. If the node 210 is a virtual machine, the corresponding node 210 and another node 210 can be secured only by changing a setting of the virtual machine.

### Outline of Capacity Change According to Embodiment

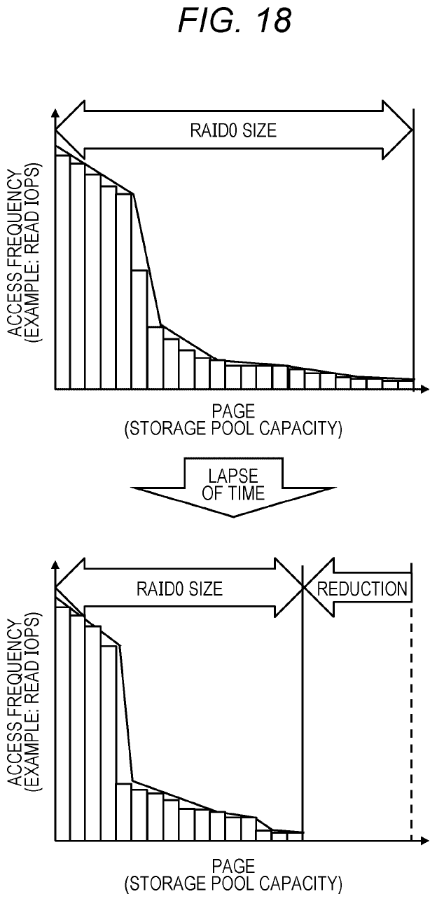

FIG. 18 is a diagram illustrating an outline of a capacity change according to the embodiment. FIG. 18 illustrates a concept of the capacity change using read access information. The upper part of FIG. 18 is a diagram illustrating a frequency distribution of the frequencies of access to the pages 210P of the storage pool 210PO at a certain time based on the monitoring result. The lower part of FIG. 18 is a diagram illustrating a frequency distribution of the frequencies of access at a time after the capacity change.

In evaluation of the capacity change based on a range of read access to the cache VOL 210CV, the RAID0 capacity is changed to match a size of the range of the read access to the cache VOL 210CV. On the other hand, in the evaluation based on the access rate to the cache VOL 210CV, a capacity corresponding to each page 210P is sequentially integrated in descending order of access frequency to calculate the overall access rate, and the RAID0 capacity is changed to a capacity at which the access rate reaches the target access rate (80% or the like).

Similarly to the read access, the capacity change is performed based on write access.

### Outline of MEC

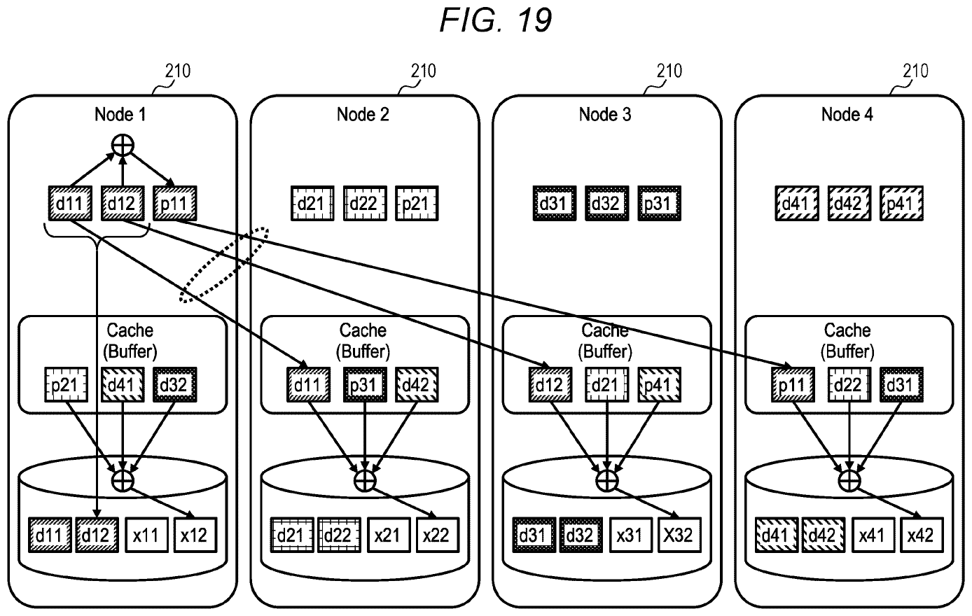

FIG. 19 is a diagram illustrating an outline of MEC. In the present embodiment, a data protection scheme of the redundant storage area 210R (FIG. 4) may be any one of RAID1, RAID5, RAID6, EC, and MEC. Hereinafter, MEC will be described.

MEC is a data protection scheme in which erasure coding is extended. All pieces of original data are stored in a local drive to speed up reading, and an erasure correction code is generated by using data of the own server and data transmitted from another server in order to improve fault tolerance.

In FIG. 19, since each of four nodes 210 (nodes 1 to 4) protects data by 2D2P, a data transfer amount is only 3. Details thereof are described below. A partial area of the memory 212 of the node 210 is a temporary storage area such as a cache area (or a buffer area).

The write processing program 2122b of a node v (v is any integer of 1 to 4) divides the received user data to be written into two user data sets dv1 and dv2, and further generates one parity pv1 as an intra-node redundant code. The parity pv1 is a primary redundant code (Class1 Code).

Next, the write processing program 2122b of the node v stores the user data sets dv1 and dv2 in the drive 214 of the node v, and transfers the user data sets dv1 and dv2 and the parity pv1 to the cache area of another node. In a case where v=1, a user data set d11 is transferred to the node 2, the user data set d12 is transferred to the node 3, and the parity p11 is transferred to the node 4. As described above, the data transfer amount is 3. The write processing program 2122b of the node v may return a response to the write request when the transfer is completed.

The write processing program 2122b of the node v generates parities xv1 and xv2 from three data sets (two user data sets and one parity) aggregated from three nodes other than the node v asynchronously with processing from reception of the write request to returning of the response. Then, the parities xv1 and xv2 are written to the drive 214 of the node v, and the cache area (an area in which the three data sets are stored) is released. The parities xv1 and xv2 are secondary redundant codes (Class2 Code).

For example, the write processing program 2122b of the node 3 generates parities x31 and x32 from the user data set d12 from the node 1, the user data set d21 from the node 2, and a parity p41 from the node 4. Then, the parities x31 and x32 are written to the drive 214 of the node 3, and the cache area (an area in which the user data sets d12 and d21 and the parity p41 are stored) is released.

FIG. 18 illustrates an example of a 2D2P redundant configuration, but the method of the present embodiment can be applied to any jDkP configuration (i and k are natural numbers of j>k). That is, the application is made as follows.
The write processing program 2122b of the node v stores the user data to be written in the drive 214 of the node v, and divides the user data into j user data sets dv1, . . . , and dvj. Then, (k−1) parities pv1, . . . , and pv(k−1) are generated based on the j user data sets dv1, . . . , and dvj. Then, each of (j+k−1) data sets (j user data sets and (k−1) parities) is transferred to each of different nodes other than the node v. That is, the transfer from the node v to (j+k−1) nodes other than the node v is performed. The data transfer amount is (j+k−1).
The write processing program 2122b of the node v generates k parities xv1, . . . , and xvk based on (j+k−1) data sets (j user data sets and (k−1) parities) from (j+k−1) nodes other than the node v. The write processing program 422 of the node v stores the k parities xv1, . . . , and xvk in the drive 214 of the node v.

### Modified Examples of Embodiment

(1)

In the above-described embodiment, data is stored in any of a plurality of storage areas (non-redundant storage area and redundant storage area) having different redundancy levels according to a processing type (read processing and write processing) of a processing source that has triggered storage processing for data in a drive. However, for example, data may also be stored in any of a plurality of storage areas having different redundancy levels according to an importance of the data associated with a volatilization setting regarding whether or not volatilization of data is allowed, in addition to the processing type of the processing source. For example, in a virtual machine, a volume attribute such as “data volatilization allowed” can be set, and data may be stored in any of a plurality of storage areas having different redundancy levels assuming that the volume attribute has a high importance. In this way, it is possible to suppress a reduction in capacity efficiency and cost efficiency of the storage system according to the importance of data.
(2)

In addition, in the above-described embodiment, data of any one data protection scheme of RAID1, RAID5, RAID6, EC, and MEC is stored in the redundant storage area. However, the present invention is not limited thereto, and data of two or more types of data protection schemes of RAID1, RAID5, RAID6, and EC and MEC having different protection levels may be stored in the redundant storage area. As a result, even in a storage system in which a plurality of types of data protection schemes are used in combination, it is possible to suppress a reduction in capacity efficiency and cost efficiency.

### Effects of Embodiment

In the above-described embodiment, when performing the storage processing for the data in the storage pool, a write destination area is selected from among a plurality of storage areas based on a processing type of a trigger of the storage processing or an importance of the data, and the data is stored in the selected storage destination area. Therefore, according to the above-described embodiment, capacity efficiency and cost efficiency of the cache volume and the physical drive can be enhanced by selecting the storage destination from among the plurality of storage areas having different redundancy levels according to an attribute of the data.

In addition, in the above-described embodiment, in a case where the processing type is the data read processing by the host, the non-redundant storage area is selected as the storage destination area in order to store the read data read in the current read processing in preparation for reading in the subsequent read processing. In addition, in a case where the processing type is the data write processing by the host, the redundant storage area is selected as the storage destination area. Therefore, according to the above-described embodiment, the data related to the read processing is stored in the non-redundant storage area and the data related to the write processing is stored in the redundant storage area, so that it is possible to increase the capacity efficiency and the cost efficiency of the cache volume while ensuring the redundancy of the data. In addition, it is possible to prevent a data loss of the data related to the write processing.

In addition, in the above-described embodiment, the read data read via the external volume is stored in the non-redundant storage area at the time of the read processing for the data from the external storage system, and the read data is read from the non-redundant storage area at the time of the subsequent read processing for the same read data. Therefore, according to the above-described embodiment, the read data from the external storage system is stored in the non-redundant storage area and is read from the non-redundant storage area, so that it is possible to achieve a high reading speed, a high capacity efficiency, and a high cost efficiency at the same time in a virtual clone function between a plurality of storage systems.

In addition, in the above-described embodiment, the redundant storage area and the non-redundant storage area are provided across a plurality of storage nodes. Then, when the read data read via the external volume by the read processing is stored in the non-redundant storage area, the non-redundant storage area residing in the storage node that has performed the read processing is preferentially selected as the storage destination area. Therefore, according to the above-described embodiment, locality of the read data can be increased, so that the data reading speed can be improved.

In addition, in the above-described embodiment, the physical drive in which an actual content of the data stored in the non-redundant storage area is stored is implemented by the instance store. Therefore, according to the above-described embodiment, the reading speed for the read data can be increased.

In addition, in the above-described embodiment, when data related to the write processing stored in the redundant storage area is stored in a physical drive together with redundant data of the data, a replica or a parity of the data is generated as the redundant data. Therefore, RAID1, RAID5, and RAID6 can be applied to the embodiment.

In addition, in the above-described embodiment, the redundant data is a parity of the data protection scheme of MEC. Therefore, the MEC can be applied to the embodiment.

In addition, in the above-described embodiment, the physical drive of the storage node is expanded or reduced according to a comparison result between a range of addresses of the logical volume accessed in response to the read request and the write request and a threshold based on the capacity of the storage pool, thereby expanding or reducing the capacity of the storage pool. Therefore, the capacities of the physical drive and the storage pool can be efficiently used according to a usage status of the cache volume.

In addition, in the above-described embodiment, the capacity of the non-redundant storage area that is the reduction target is reduced after the data stored in the non-redundant storage area that is the reduction target is discarded, and when the read request for the discarded data is received, the data is read from the external storage system and returned as a response to the host. Therefore, according to the above-described embodiment, it is possible to actively reduce the capacity of the non-redundant storage area on the premise of re-reading the data from the external storage system, and it is possible to improve efficiency in utilization of the capacities of the physical drive and the storage pool.

In addition, in the above-described embodiment, the capacity of the redundant storage area that is the reduction target is reduced after the data stored in the redundant storage area that is the reduction target is migrated to the redundant storage area that is not the reduction target. Therefore, according to the above-described embodiment, the capacity of the redundant storage area can be actively reduced on the premise of the migration of the data, and it is possible to improve the efficiency in utilization of the capacities of the physical drive and the storage pool.

Although some embodiments have been described above, these are examples for describing the present invention and it is not intended to limit the scope of the present invention only to these embodiments. The present invention can also be implemented in various other modes such as a mode in which a part of the configuration of each of the above-described embodiments is deleted, a mode in which at least a part of the configuration is replaced, a mode in which a configuration is added, and a mode in which some or all of the embodiments are combined.

What is claimed is:

1. A storage system comprising a plurality of storage nodes, wherein
each of the storage nodes includes:
a logical volume storing data related to an input/output (I/O) request from a host;
a storage pool including a plurality of storage areas having different redundancy levels and in which the data stored at an address of the logical volume is logically stored at an address mapped to the address;
a physical drive in which an actual content of the data logically stored in the storage pool is stored;
a memory storing management information including mapping information between the address of the logical volume and the address of the storage pool; and
a processor connected to the memory, and
the processor selects, when performing storage processing for the data in the storage pool, a storage destination area from among the plurality of storage areas based on a processing type of the I/O request that has triggered the storage processing or an importance of the data, and stores the data in the selected storage destination area.

2. The storage system according to claim 1, wherein
the plurality of storage areas include a redundant storage area in which the data is stored together with redundant data of the data and a non-redundant storage area in which the data is stored in a non-redundant manner, and
the processor
selects and stores the non-redundant storage area as the storage destination area and transfers the stored data to the host in a case where the processing type is data read processing by the host, and
selects and stores the redundant storage area as the storage destination area and stores the stored data in the physical drive in a case where the processing type is data write processing by the host.

3. The storage system according to claim 2, wherein
each of the storage nodes includes an external volume connected to an external storage system, and
in response to the I/O request from the host,
the processor
stores read data read via the external volume in the non-redundant storage area and returns the read data as a response to the host in the data read processing from the external storage system, and
reads the read data from the non-redundant storage area and returns the read data as a response to the host in the read processing performed again for the read data returned as a response to the host by the read processing.

4. The storage system according to claim 3, wherein
the redundant storage area and the non-redundant storage area are provided across the plurality of storage nodes, and
the processor preferentially selects, as the storage destination area, the non-redundant storage area residing in the storage node that has performed the read processing when storing the read data read via the external volume by the read processing in the non-redundant storage area.

5. The storage system according to claim 3, wherein the actual content of the data stored in the non-redundant storage area is stored in an instance store.

6. The storage system according to claim 2, wherein
the processor
stores the data related to the read processing and the write processing in a cache, and
determines whether a storing area for storing the data that is a storage target is the redundant storage area or the non-redundant storage area, generates the redundant data and adds the redundant data to the storage target in a case where a storage destination is the redundant storage area, and stores the storage target in either the redundant storage area or the non-redundant storage area when storing the data stored in the cache in the storage pool.

7. The storage system according to claim 2, wherein
the plurality of storage nodes adopt a data protection scheme of erasure coding,
the processor
divides the data to be subjected to the write processing to an own storage node, stores the data in the storage pool of the own storage node, generates a first parity based on a plurality of data sets obtained by the division, and
transfers each of the plurality of data sets and the first parity to each of the storage nodes other than the own storage node, and
the processor of the other storage node
receives the data set and the first parity from another storage node, and
generates a second parity as the redundant data based on the received data set and the first parity.

8. The storage system according to claim 3, wherein
the processor
monitors an access frequency for each page of the logical volume, and
expands or reduces a capacity of the redundant storage area or the non-redundant storage area based on the access frequency of each page.

9. The storage system according to claim 8, wherein
the processor
expands or reduces the capacity of the redundant storage area based on the access frequency for each page related to the write processing, and
expands or reduces the capacity of the non-redundant storage area based on the access frequency for each page related to the read processing.

10. The storage system according to claim 9, wherein
the processor
discards the data stored in the non-redundant storage area that is a reduction target and then reduces the capacity of the non-redundant storage area that is the reduction target when reducing the capacity of the non-redundant storage area, and
reads, when a read request for the discarded data is received, the data from the external storage system and returns the data as a response to the host.

11. The storage system according to claim 9, wherein
the processor
moves the data to be moved stored in the redundant storage area that is a reduction target to the redundant storage area that is not the reduction target and then reduces the capacity of the redundant storage area that is the reduction target when reducing the capacity of the redundant storage area, and
reads, when a read request for the data to be moved is received, the data to be moved from the redundant storage area that is not the reduction target and is a movement destination and returns the data as a response to the host.

12. The storage system according to claim 8, wherein the processor expands or reduces the capacity of the redundant storage area or the non-redundant storage area based on the number of pages of which the access frequency is high and which account for a predetermined percentage of accesses.

13. A storage system control method executed by a storage system including a plurality of storage nodes,
each of the storage nodes including
a logical volume storing data related to an input/output (I/O) request from a host,
a storage pool including a plurality of storage areas having different redundancy levels and in which the data stored at an address of the logical volume is logically stored at an address mapped to the address,
a physical drive in which an actual content of the data logically stored in the storage pool is stored,
a memory storing management information including mapping information between the address of the logical volume and the address of the storage pool, and
a processor connected to the memory,
the storage system control method comprising processing of:
selecting, by the processor, a storage destination area from among the plurality of storage areas based on a processing type of the I/O request that has triggered the storage processing or an importance of the data when performing storage processing for the data in the storage pool; and
storing, by the processor, the data in the selected storage destination area.
